(19) United States
(12) Patent Application Publication
(10) Pub. No.: US 2004/0193914 A1
(43) Pub. Date: Sep. 30, 2004

(54) Method for protecting embedded software

(76) Inventor: Chen Chih-Wei, Taipei (TW)

Correspondence Address: BIRCH STEWART KOLASCH & BIRCH, PO BOX 747, FALLS CHURCH, VA, 22040-0747, US

(21) Appl. No.: 10/697,304

(22) Filed: Oct. 31, 2003

(30) Foreign Application Priority Data
Mar. 27, 2003 (TW) 092106879

(51) Int. Cl. H04L 9/00; G06F 17/60

(52) U.S. Cl. 713/200; 705/52

(57) ABSTRACT

A method for protecting embedded software is proposed which uses a transfer function of the firmware in an electronic information appliance to prevent the execution of the embedded software in an unauthorized hardware. Before parameters are called upon, the main program of the embedded software stores the parameters in a buffer. And through the transfer function, the parameters in the buffer are then shifted according to a different sequence to another storage interface. As the auxiliary program is subsequently called upon, it does not carry any parameters, since the parameters are stored in another storage interface. So, the parameters need to be extracted from a default parameter address and decoded. Correct parameter data is required to effect a normal execution of the selected function of the software. If the extracted parameter data is erroneous, execution of embedded software in the unauthorized hardware is disabled.

### BACKGROUND OF THE INVENTION

1. Field of the Invention

The invention relates to a method for protecting embedded software and, more particularly, to a method for protecting embedded software from being used in an unauthorized hardware.

2. Description of the Related Art

In the present digital era, data processing appliances are becoming increasingly indispensable as rapid developments are made in the field of information technology. To satisfy consumer demands, new designs are constantly promoted, and intense competition takes place between the industrial manufacturers.

To be competitive and to be accepted by the public, a product should not only contain a pleasant aesthetic aspect and hardware with the adequate performance, but it must also be user-friendly. From this consideration, embedded software plays an important role in the value and the competitiveness of an information appliance. Embedded software is usually stored in the internal part of the hardware, and is in charge of hardware driving, sequence control, and interface processing. The quality of embedded software therefore may decide the success of the product, which makes it vulnerable to fraudulent duplication that potentially damage the original designer and also impedes further improvements.

Although embedded software is stored in the internal part of the hardware, it is not inseparable from the hardware. Unauthorized use of embedded software may be easily accomplished through simply copying its execution code, and then the embedded software can be executed on other hardware. A competitor, therefore, may easily acquire the embedded software and use it in a product that is sold with a lower price. Such fraudulent use of embedded software may induce substantial damages to the proprietor that has invested enormous time and money in the development of the embedded software.

To overcome the above problem, some programmers may incorporate a verification program in the embedded software that, when the embedded software is executed in the hardware, verifies whether certain utilization parameters of the hardware correspond to the designer's settings. If the verification program is successful, the embedded software execute normally, otherwise execution of the embedded software is disabled. Although this verification program technique provides basic protection, it is however insufficient to deter and prevent an expert programmer who skills in the art from modifying the verification parameters by using a software tool to simulate a success of the verification program or even skip the verification program altogether. As a result, the embedded software is still vulnerable to unauthorized use in an unauthorized hardware.

Therefore, effective measures are needed to protect embedded software from the unauthorized use.

### SUMMARY OF THE INVENTION

It is an objective of the invention to provide a method for protecting embedded software, whereby mechanisms of the embedded software are modified to necessarily operate in coordination with a hardware without being decoded or cracked out easily to prevent unauthorized modification of the software.

To achieve the above and other objectives, a method for protecting embedded software is proposed, whereby the software is protected without verifying hardware. The software is protected via basic input/output system (BIOS) functions of the hardware. Since the BIOS is a firmware integrated with the main board of an information appliance, the BIOS is linked to the hardware installed within the information appliance. If the embedded software is associated with an unauthorized BIOS, in other words the embedded software is used within an unauthorized hardware, the BIOS settings of the unauthorized hardware consequently differ from the BIOS settings of the authorized hardware, disabling execution of the embedded software in the non-authorized hardware. As the BIOS is highly related to the hardware, it is difficult to crack out the embedded software by using a software tool. The embedded software is thereby effectively protected from illegal duplication.

According to the invention, the method for protecting the embedded software comprises the following steps. When a user desires to use a function of the software embedded in an information appliance, a main program of the embedded software stores parameters to be transmitted in a buffer assembled within the information appliance. Through a function provided by the BIOS, an authorization to control the parameters is transferred to the BIOS of the information appliance. Upon acquisition of the authorization, the BIOS encodes and rearranges the parameters stored in the buffer, and shifts the parameters according to different sequences to another storing interface. Once the authorization is then returned to the embedded software, the main program of the embedded software calls and passes the authorization to an auxiliary program. The auxiliary program then extracts the parameters from default parameter addresses, and determines whether the parameters are correct. If the extracted parameters are correct, functions of the software are executed in the hardware. If the parameters are erroneous, which means that the embedded software is running in the unauthorized hardware, execution of the software function is prohibited.

By linking the execution of the embedded software with the BIOS of the hardware, usage of the embedded software on unauthorized hardware is therefore effectively blocked. The embedded software is thereby protected from unauthorized access.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a block diagram schematically illustrating a layout for executing protective measures when the storage management software embedded in a storage server is operated according to one embodiment of the present invention; and

FIG. 2 is a flow chart illustrating steps involved in the method for protecting the embedded software, implemented in executing the storage management software in a storage server, according to one embodiment of the present invention.

### DETAILED DESCRIPTION OF THE EMBODIMENTS

Wherever possible in the following description, like reference numerals will refer to like elements and parts unless otherwise illustrated.

The method for protecting embedded software according to the invention is implemented in, for example, a storage server to prevent embedded software, such as a storage management software, from being copied and used in another server without authorization. It will be understood that the implementation of the software protection method according to the invention is not limited to the storage management software of a storage server, but may be applicable to any information appliance having the embedded software to provide a protective measure for the embedded software included in the information appliance.

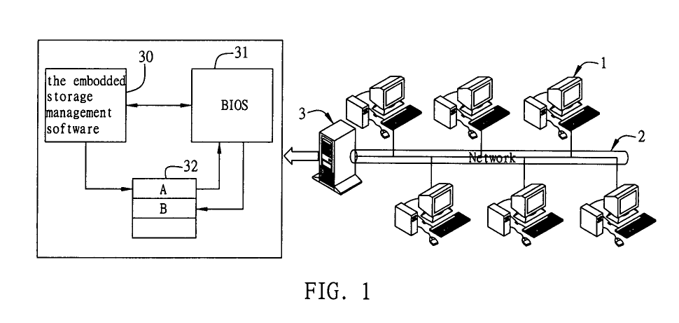

Referring to FIG. 1, the block diagram schematically illustrates a layout of executing protective measures for the storage management software embedded in a storage server according to one embodiment of the present invention. As illustrated, once a user on a user terminal 1 has logged on via a network 2 to a storage server 3 enters a standby status, waiting for the user to select and command the execution of a function from the embedded storage management software 30. As the user has selected a disk array related function provided by the storage management software 30, the storage management software 30 executes the disk array function according to its default flow chart. Before the associated disk array auxiliary program is called, a main program of the storage management software 30 first stores the parameters to be transmitted to the disk array auxiliary program in address A within a memory 32. Next, the storage management software 30 calls a appliance management interrupt (SMI) application provided by the BIOS 31, and passes a specific parameter to inform the SMI application for the tasks to be executed. In other words, the invention uses the characteristics of the SMI to achieve the method for protecting the storage management software 30.

The embedded application software (storage management software 30) may include numerous functions, and most of them being implemented through function calls with transmission of the parameters, typically in the form of: call function (parameter 1, . . . , parameter n). As described above, the invention uses the SMI application as a parameter transmission tool. After the main program has stored the parameters (originally destined for the disk array auxiliary program) in the address A of the memory 32, function of the SMI application is called to pass parameter access authorization to the BIOS 31. Upon acquisition of the parameter access authorization, the BIOS 31 encodes and rearranges the parameters stored in address A of the memory 32, and shifts these parameters based on a different sequence to another address B of the memory 32 to be stored. Through the function of SMI application, the BIOS 31 then transferred the authorization to the storage management software 30, which in turns, calls and passes the authorization to the disk array auxiliary program.

As the BIOS 31 has previously moved the parameters to address B, the disk array auxiliary program called by the storage management software 30 does not carry any parameters. So, the disk array auxiliary program needs to extract and decode the parameters from the default parameter addresses in the BIOS 31, so as to restore the original parameters. The correct parameters enable the disk array function selected by the user to continue proper execution in the storage server 3.

Alternatively, if the storage management software 30 is stolen and is executed in the unauthorized storage server, the parameters extracted from the default addresses set in the BIOS 31 by the disk array auxiliary program are erroneous. As a result, the disk array function cannot be executed using the correct parameters, and a principal function of the storage server is thereby disabled.

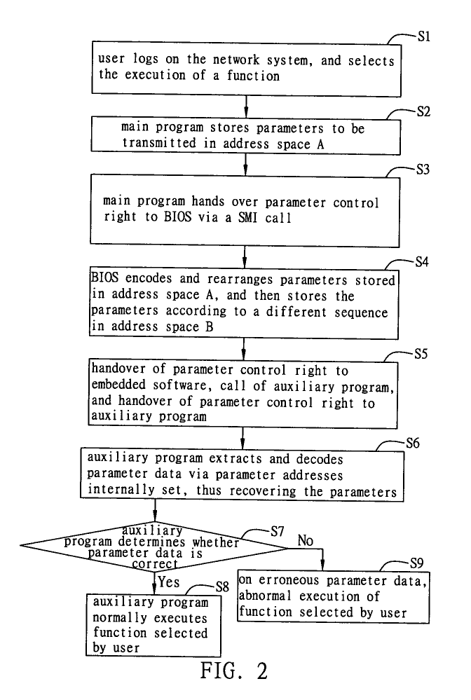

Referring to FIG. 2, the flow chart schematically illustrates steps involved in the method for protecting the embedded software, implemented in executing the storage management software in a storage server, according to one embodiment of the present invention. In step S1, a user on a user terminal 1 logs on to the storage server 3 through a network 2, and then selects a disk array function in the storage management software 30. Then step S2 is executed.

In step S2, before the disk array auxiliary program is called, the main program of the storage management software 30 stores the parameters initially to be transmitted to the disk array auxiliary program in address A of the memory 32. The execution program may be written as follows:

write par_{—}1 to memory;

write par_{—}2 to memory;

. . . . . . ;

write par_{—}1 to memory.

Step S3 is then executed. In step S3, the main program of the storage management software 30 calls a function of SMI application through a standard defined by the BIOS 31. Through the SMI function call, the parameter access authorization is transferred to the BIOS 31, which in turn, rearranges the parameters according to a different sequence. The instruction program may be illustrated as follows:

call an SMI function with a parameter to rearrange the par_{—}1˜par_n into CMOS Non-volatile RAM;

call function ( );

. . . . . . ;

end;

Step S4 is then executed. In step S4, after the BIOS 30 has acquired authorization to access parameters stored in address A, the BIOS 31 encodes and rearranges these parameters are encoded and rearranged. The BIOS 31 shifts the parameters in address A according to different sequences to another address B of the memory 32 to be stored, so as to adjust the sequences of these parameters. A corresponding program may be illustrated as follows:

BIOS SMI code:

get par_{—}1 from memory;

. . . . . . ;

get par_{—}1 from memory;

clear all memory buffer;

put par_{—}5 to CMOS Non-volatile RAM;

put par_{—}1 to CMOS

put par_{—}1 to CMOS;

. . . . . . ;

Step S5 is then executed. In step S5, after the BIOS 31 has completed adjusting the parameter sequences, the BIOS 31 hands over the parameter access authorization to the main program of the storage management software 30. The main program then calls and passes the authorization to the disk array auxiliary program to execute the function selected by the user. However, as the BIOS 31 has previously stored the parameters in address B, the disk array auxiliary program, when called by the main program, does not include or carry any parameter data needed for its execution. Step S6 is then executed.

In step S6, since there is no parameter provided for the disk array auxiliary program to execute its function, the disk array auxiliary program needs to extract parameters from the default parameter addresses, and decodes them to restore the initial parameter contents. Step S7 is then executed.

In step S7, the disk array auxiliary program determines whether the restored parameter data is correct. If the parameter data is correct, step S8 is executed, otherwise step S9 is executed.

In step S8, the disk array auxiliary program uses the correct parameter data to execute the function selected by the user.

In step S9, incorrect parameter data indicates that the storage management software 30 is operating in a storage server without authorization, in other words, that the storage management software 30 has been accessed without authorization. That means the data extracted from the default parameter addresses in the BIOS 31 is not the parameters initially stored by the BIOS 31. Therefore, execution of the disk array function on the storage server 3 without authorization is prohibited.

As described above, the method for protecting embedded software uses the SMI function of the BIOS to rearrange and encode the parameter sequence. The parameters required for executing the software program are stored in default parameter addresses in the BIOS. The software can properly operate only in coordination with the BIOS integrated in the authorized hardware, and cannot be used in any other unauthorized hardware. By such coordination between the BIOS and the hardware, the protection method of the invention thereby effectively is achieved to prevent illegal duplication and use of the software.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method for protecting an embedded software, whereby a verification mechanism of the embedded software is modified as to require the embedded software to be operated in coordination with hardware characteristics of an authorized electronic information appliance, the electronic information appliance having a storage device and firmware to enable execution of the embedded software only in the authorized electronic information appliance, the method comprising steps of:
(1) having a first program of the embedded software store parameters to be transmitted in a first address of the storage device, and having the embedded software pass a parameter access authorization through a function of the firmware to the firmware of the electronic information appliance;
(2) having the firmware rearrange and store the parameters in a second address of the storage device, and handing over the authorization to the embedded software; and
(3) having the embedded software call and pass the authorization to a second program of the embedded software, and having the second program extract the parameters from a default parameter address, and determining whether the parameters are correct, wherein, if the parameters are correct, the embedded software is properly executed, otherwise the embedded software is disabled.

2. The method of claim 1, wherein the electronic information appliance is a storage server.

3. The method of claim 1, wherein the storage device is a memory.

4. The method of claim 1, wherein the firmware is a basic input/output system (BIOS).

5. The method of claim 1, wherein the first program is a main program of the embedded software.

6. The method of claim 1, wherein the address of the storage device in step (1) is a buffer in the memory.

7. The method of claim 1, wherein the function provided by the firmware is an appliance management interrupt (SMI) function.

8. The method of claim 1, further comprising encoding and rearranging the sequence of the parameters before having the firmware rearrange and store the parameters according to a different sequence in a second address of the storage device in step (2).

9. The method of claim 1, wherein the second program is an auxiliary program of the embedded software.

10. The method of claim 1, wherein the embedded software is storage management software.
